(19) United States
(12) Patent Application Publication
(10) Pub. No.: US 2022/0055091 A1
(43) Pub. Date: Feb. 24, 2022

(54) A Tool, a Method and an Apparatus for Mounting Rods Around a Central Core

(71) Applicant: Air Toolbox AS, As (NO)

(72) Inventors: Markus Leonhard Hansen, Kvaloya (NO); Cornelis Arnoldussen, As (NO); Ole Petter Berger, As (NO)

(21) Appl. No.: 17/298,762

(22) PCT Filed: Nov. 28, 2019
(86) PCT No.: PCT/EP2019/082871

§ 371 Date: Jun. 1, 2021

(30) Foreign Application Priority Data
Nov. 29, 2018 (NO) 20181543

(51) Int. Cl. B21F 17/00; B21C 37/12; H01B 7/22; H01B 13/26

(52) U.S. Cl. CPC B21F 17/00; H01B 13/26; H01B 7/226; B21C 37/126

(57) ABSTRACT

A tool for mounting a set of helical rods around an elongated central core includes a pair of cartridges mounted opposite each other around the central core, so that the rods extend along the central core. Each cartridge has a first part comprising a through-hole for receiving one of the rods, and a second part comprising a through-hole for receiving another rod, the second part being movable with respect to the first part from an open position to a closed position. In the closed position, the parts form an annular body extending around a central opening for receiving the central core, the cartridge comprising a surface configured to engage with a driving wheel or a driving belt for transfer of torque to the cartridge. In the open position, a gap is provided between the parts so that the central opening is accessible from a position radially outside of the cartridge.

### CROSS-REFERENCE TO RELATED APPLICATION(S)

This application is a national stage 371 application of PCT/EP2019/082871, filed on Nov. 28, 2019, which claims priority to and the benefit of Norway Application Patent Serial No. 20181543, filed Nov. 29, 2018, the entire disclosures of which are hereby incorporated by reference.

### TECHNICAL FIELD

The present invention relates to a tool for mounting a set of preformed helical rods around a central core extending along a longitudinal axis and to a tool assembly comprising such a tool. The invention further relates to a method and an apparatus for mounting a set of preformed helical rods around a central core extending along a longitudinal axis.

### BACKGROUND

Cables, conductors, wires and power lines are commonly protected by means of preformed helical rods, also commonly referred to as armor rods. A set of armor rods are wrapped around the cable which they are to protect such that they cover the cable. The armor rods serve to protect the cable from wear and from being damaged by external forces applied on the cable. They also increase the overall cross-section of the cable, thereby reducing the bending moment and the tensile stress. Furthermore, the armor rods can be used to increase the electrical conductivity, which reduces heat generation and damages associated with such heat generation.

Armor rods are commonly mounted manually, one by one, to fully or partially cover the cable or a portion thereof. This is a time consuming process. Attempts to automate the mounting process have been made, but the quality achievable using known automated processes and machines is generally inferior in comparison with manual mounting processes.

One reason for the complexity of optimizing or automating the mounting of preformed helical rods is the combination of multiple physical parameters. For example, the preformed helical armor rod, generally made of two superposed sinusoids, needs to be combined with a helicoidal rotation of the mounting tool. Other parameters relate to the mechanical characteristics of the rods, such as bending moment and tensile stress. These parameters may vary on one hand along each rod and on the other hand during the mounting operation, depending on the torsion and elongation during installation. This complexity is not easily modelled. Therefore, time consuming manual mounting of preformed helical armor rods is still preferred to achieve a high quality.

In particular, it has been found difficult to wrap terminations of the armor rods sufficiently close to the cable using automated mounting processes. This results in protruding armor rod terminations, which typically generate corona effects and thereby lead to fast degradation of the cables. It should also be noted that corona effects give rise to major operations and safety issues in powerline applications. For this reason, terminations of the armor rods for such applications may be machined after cutting to length in order to provide a rounded termination without corona-inducing sharp ridges resulting from the rod cutting operation. This may also explain special production of preformed armor rods with straight terminations, instead of the cheaper regular preformed rod produced by cutting a helical “endless” rod at regular intervals.

In view of the above, there has been a long-felt need for improved mounting of helical rods around cables for many years.

### SUMMARY

It is a primary object of the present invention to overcome or alleviate at least one of the disadvantages of the prior art, or to provide a useful alternative. In particular, it is an object of the invention to facilitate installation of a set of preformed helical rods around a central core, such as a cable or another type of conductor.

At least the primary object defined above may be achieved by the subject-matter of claim 1. Embodiments are set forth in the appended dependent claims, in the following description and in the drawings.

The present invention relates to a tool for mounting a set of preformed helical rods around a central core extending along a longitudinal axis, the tool comprising a pair of cartridges configured to hold the rods and configured to be mounted around the central core opposite each other along the longitudinal axis, so that the rods extend along the central core, each cartridge comprising at least:

a first part comprising at least one through-hole for receiving at least one of said rods,
a second part comprising at least one through-hole for receiving at least another one of said rods,
the second part being movable with respect to the first part from an open position to a closed position,
wherein, in the closed position, the first part and the second part together form an annular body extending around a central opening for receiving the central core, the through-holes being arranged around the central opening at equal radial distances to a central axis of the cartridge, the cartridge comprising a surface configured to engage with a driving wheel or a driving belt for transfer of torque to the cartridge, and
wherein, in the open position, a gap is provided between the parts so that the central opening is accessible from a position radially outside of the cartridge.

The proposed tool serves to facilitate the rod mounting process and also enables an automation of this process. Several rods may be pre-loaded in the pair of cartridges in such a manner that the tool and the rods form a rigid unit. The rods are thereafter simultaneously mounted around the central core. Thus, all the rods needed to protect the central core may be mounted at the same time in an efficient manner. The tool may be stored and/or transported pre-loaded with rods, thereby enabling time efficient installation on site.

Since the two parts of each cartridge are movable with respect to each other, it is possible to place the tool, loaded with rods, around the central core without having access to an end of the central core. This is useful for example in order to mount armor rods around an already installed cable.

When a surface of the cartridge is configured to engage with a driving wheel, it is possible to transfer torque to the cartridges without having to use e.g. operating sticks that must be moved around the central core to different attack points. Instead, torque may be generated by a motor located beside the tool and transferred to the cartridge by means of a driving wheel. The torque may thereby be transferred to the cartridge at an attack point which is rotationally fixed with respect to the central core.

Of course, each cartridge may comprise more than two parts. For example, the cartridge may comprise three or four similar parts, each part forming a sector of the annular body. The cartridge may also comprise one or more parts used to lock the cartridge in its closed position and/or in its open position, and/or one or more parts used to assist in the relative movement of the parts, etc.

The rods, when mounted in the cartridges, preferably extend along the central core but not in parallel with the central core. Instead, longitudinal axes of the rods diverge slightly in an axial direction away from the tool.

According to one embodiment, the second part is configured to be pivotable with respect to the first part around a pivot axis parallel with the central axis. This facilitates handling of the tool and mounting of the rods. The cartridge may in this case comprise a hinge joint at which the first and the second part are connected. Alternatively, or additionally, the second part may be arranged to be translatable in a radial direction of the cartridge with respect to the first part, such that a gap is provided between the parts.

According to one embodiment, the first part and the second part each comprise a plurality of said through-holes, respectively, wherein said through-holes are evenly distributed around the central axis, i.e. an angular distance between each pair of through-holes is equal or essentially equal. An even distribution of the rods around the central core after mounting, without gaps between the rods, may thereby be achieved.

According to one embodiment, the first part and the second part each comprise opposite front and rear axial side surfaces, the cartridges being arranged with said rear axial side surfaces facing each other, wherein each of said through-holes is located in a with said through-hole associated recess formed in the rear axial side surface, wherein said recess is wedge-shaped and delimited by side walls extending in a radial or essentially radial direction of the cartridge, wherein the side walls are offset by an angle. The wedge-shaped recesses serve to guide the helical rods during wrapping, contributing to a close wrapping of the helical rods around the core. In this way, also terminations of the rods may be wrapped close to the central core, such that corona effects arising from protruding rod terminations are efficiently prevented. Thus, there is no need for more expensive preformed helical rods with straight rod terminations.

The wedge-shaped recesses provide additional space for the rods behind the through-holes, and at the same time the side walls restrict the degree of freedom of the rods. Thereby, tension and bending of the rods may be prevented. Additionally, the side walls enable for the rods to rotate about their own longitudinal axes as the two cartridges are pushed toward one another, thereby forming a rigid unit.

The side walls may comprise planar surfaces delimiting the recess. Alternatively, the side walls may comprise non-planar surfaces. However, in both cases, a distance between the side walls delimiting the recess should increase in a radial direction of the cartridge, away from the central axis. For example, in the case of planar surfaces, the distance between the side walls increases linearly in the radial direction away from the central axis.

The recess may e.g. have the shape of a circular ring sector (annulus sector) or similar. The angular offset between the side walls depends on e.g. the number of through-holes and the radius and the pitch of the preformed helical rods. The side walls may preferably be made as thin as practically possible.

The recess preferably has a radial extension, i.e. in a radial direction of the cartridge, which is larger than an extension of the through-hole in that direction, such that the recess extends at least from the through-hole and toward an inner position closer to the central axis. Preferably, the recess extends at least from the through-hole and to the inner position located radially inside of the through-hole. The rods are thereby allowed to drop close to the central core as they wrap around it.

Preferably, the recess extends from an outer position located radially outside of the through-hole to an inner position located radially inside of the through-hole.

An extension of the side walls in the radial or essentially radial direction may be from a few millimetres to a few centimetres, depending on the size of the tool and on the dimensions and characteristics of the rods and the central core, such as a diameter of the helical rods, a pitch of the helical rods, a material of the rods, and a diameter of the central core. The side walls may in some embodiments have a radial extension of 0.5-10 cm, or 1-8 cm, or 1-6 cm. For example, the side walls may have a radial extension of 1 cm, 2 cm, 3 cm, 4 cm, 5 cm, or more.

Optionally, the recess is delimited in the radial direction by an outer side wall located radially outside of the through-hole and an inner side wall located radially inside of the through-hole. The inner and outer side walls may in some embodiments be omitted. The inner and outer side walls may also partly delimit the recess in the radial direction. The outer side wall may have a larger extension in a circumferential direction of the cartridge than the inner side wall. The outer side wall may for example have an extension of 0.5-10 10 cm, such as 1-8 cm, or 2-6 cm, depending on for example the diameter of the rods.

A depth of the recesses as measured in an axial direction along the central axis may e.g. be 1-10 cm, or 1-6 cm, or 2-5 cm, for example 1 cm, 2 cm, 3 cm, 4 cm, 5 cm, or more.

According to one embodiment, the surface configured to engage with the driving wheel or driving belt is a radially peripheral surface of the annular body. The radially peripheral surface may in this embodiment comprise teeth for torque transfer using e.g. a driving wheel in the form of a pinion. Efficient transfer of torque is thereby enabled. With such an external gear, the tool size can be reduced in comparison with embodiments in which an internal gear is provided.

According to one embodiment, the surface configured to engage with the driving wheel or driving belt is configured for meshing engagement with a driving wheel. Efficient transfer of torque is thereby enabled.

In another aspect, the invention relates to a tool assembly comprising the proposed tool and a set of preformed helical rods, each rod being received in one of said through-holes of a first one of the cartridges and one of said through-holes of a second one of the cartridges positioned opposite to the first cartridge along the central axis of the first cartridge in such a manner that the tool and the rods form a rigid unit.

Such a tool assembly forming a rigid unit may be stored and/or transported ready for use, thereby enabling time efficient installation on site. Since the tool assembly forms a rigid unit, it is easy to handle prior to installation.

In another aspect, the invention relates to a method for mounting a set of preformed helical rods around a central core extending along a longitudinal axis, the method comprising: providing the proposed tool, the set of rods being loaded in the pair of cartridges, each rod being received in one of said through-holes of a first one of the cartridges and one of said through-holes of a second one of the cartridges positioned opposite to the first cartridge along the central axis of the first cartridge,

with the cartridges in the open position, positioning the pair of cartridges with the rods loaded therein around the central core and subsequently closing the cartridges such that the central core is received in the central opening of each cartridge,
subsequently to closing the cartridges, rotating the cartridges in opposite directions around the central core until a predetermined condition is met,
subsequently to the predetermined condition being met, simultaneously rotating and translating the cartridges in opposite directions around and along the central core, respectively, so that the rods wrap around the central core.

Advantages and advantageous features of such a method appear from the above description of the proposed tool. Furthermore, the initial rotation in opposite directions around the central core facilitates tight wrapping of the rods around the central core. This initial rotation of the cartridges may preferably, but not necessarily, be simultaneously performed.

Thanks to the use of cartridges and the translation of these cartridges in opposite directions along the central core, the method is well suited for mounting of preformed helical rods with different geometrical characteristics, such as rods of different lengths and/or different diameters. The rods may have a length from several decimetres to several meters, such as from 0.5 meters to 5 meters, for example 1 m, 2 m, 3 m, or 4 m. The rods may have a diameter of 1-20 mm, for example 1-14 mm, depending on the application and on the diameter of the core. For example, galvanized steel rods for use with cores having a diameter of 6-15 mm may in some cases have a diameter of 1.5-4 mm, and aluminium rods for use with cores having a diameter of 5-14 mm may in some cases have a diameter of 3-5 mm, wherein generally the diameter of the rod increases with the diameter of the core.

According to one embodiment, rotating each cartridge is carried out using a driving wheel in meshing engagement with a surface of the cartridge, preferably a radially peripheral surface of the cartridge. Efficient transfer of torque is thereby enabled.

According to one embodiment, the predetermined condition is considered to be met when at least one of the rods comes into contact with the central core. The rods are thereby in an appropriate position to start translational movement of the cartridges in opposite directions along the central core.

According to one embodiment, the predetermined condition is considered to be met when the cartridges have been rotated by a predetermined angular amount. The angular amount may typically be a total angular amount of 180°, such as when the cartridges have been rotated 90° in opposite directions. Usually, at this point, at least one of the rods has come into contact with the central core.

According to one embodiment, the rods are loaded in the pair of cartridges so that a first point of contact between one of the rods and the first cartridge is separated from a second point of contact between said rod and the second cartridge by an amount equal to a helical pitch of said rod. The points of contact are herein located at the central through-holes. The pair of cartridges may, after loading of the rods in the through-holes, be pushed toward each other to form a stable and rigid unit. The points of contact are thereby provided at the “top” of two adjacent sinus periods.

In yet another aspect, the invention relates to an apparatus for mounting a set of preformed helical rods around a central core extending along a longitudinal axis, the apparatus comprising the proposed tool, the apparatus further comprising:

a frame comprising two frame members, each frame member being configured to hold one of the cartridges centred on the central core, wherein the frame members are movable along the longitudinal axis,
rotational driving means for rotating the cartridges,
translational driving means for translating the frame members along the longitudinal axis,
control means configured to control the rotational driving means and the translational driving means so that the cartridges are rotated in opposite directions around the central core until a predetermined condition is met, and so that the cartridges are subsequently simultaneously rotated and translated in opposite directions around and along the central core, respectively.

The apparatus according to the invention enables efficient automated mounting of preformed helical rods around a central core. In particular, the cartridges make it possible to provide one or more tools pre-loaded with preformed helical rods for use in the apparatus. Thus, as the apparatus wraps the central core by means of a first tool loaded with a first set of rods, a second tool may be pre-loaded with a second set of rods such that it is ready for wrapping around the central core as soon as the operation using the first tool is finished. Regardless of whether the apparatus comprises a magazine filled with pre-loaded tools, or whether an operator of the apparatus manually provides the pre-loaded tools to the frame members of the apparatus, downtime between two subsequent wrapping operations may be minimized.

Further advantages and advantageous features of such an apparatus appear from the above description of the proposed tool and method.

According to one embodiment, the rotational driving means comprises a first and a second driving wheel configured to translate torque to the cartridges by engagement with surfaces of a first one and a second one of the cartridges, respectively. Efficient torque transfer is thereby achieved.

According to one embodiment, the apparatus further comprises a mounting device for mounting the cartridges around the central core, wherein the mounting device is configured to hold the cartridges opposite one another in the open position, with the gaps facing the central core, and move the cartridges simultaneously in a radial direction of the cartridges until the cartridges are centred on the central core, and subsequently close the cartridges. The mounting device facilitates mounting of the cartridges around the central core. The frame members may be translated onto the cartridges after closing the cartridges using the translational driving means.

Further advantages and advantageous features will appear from the following detailed description.

### DEFINITIONS

By a central core extending along a longitudinal axis is herein intended an elongated object such as a cable, a conductor, a wire, a power line or the like.

The preformed helical rods may herein also be referred to as rods.

A radially peripheral surface is to be understood as a surface delimiting the cartridge in the radial direction of the annular body. The surface does not necessarily need to be transverse to the radial direction.

### BRIEF DESCRIPTION OF THE DRAWINGS

The present invention will hereinafter be further explained by means of non-limiting examples with reference to the appended drawings, wherein:

FIG. 1 is a perspective view of a tool according to an embodiment of the invention, loaded with a set of rods, with the tool in a closed position;

FIG. 2 is a perspective view of a tool according to an embodiment of the invention, loaded with a set of rods, with the tool in an open position;

FIG. 3 is a rear end view of a cartridge according to an embodiment of the invention;

FIG. 4 shows an apparatus according to an embodiment of the invention, with the tool in the open position;

FIG. 5 shows the apparatus in FIG. 4 with the tool in the closed position; and

FIG. 6 is a flow chart illustrating a method according to an embodiment of the invention.

It should be noted that the appended drawings are schematic and that individual components are not necessarily drawn to scale and that the dimensions of some features of the present invention may have been exaggerated for the sake of clarity.

### DETAILED DESCRIPTION

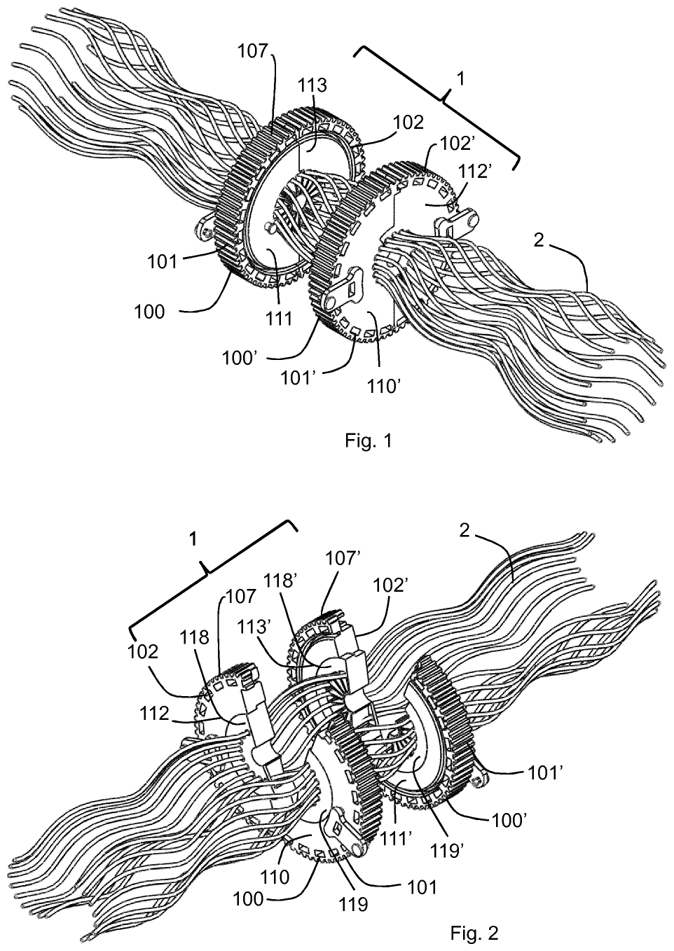

FIG. 1 and FIG. 2 illustrate a tool 1 for mounting a set of preformed helical rods 2 around a central core (not shown in FIGS. 1 and 2) according to embodiments of the invention in a closed positon and in an open position, respectively. The tool 1 comprises a pair of cartridges 100, 100′ configured to hold the rods 2. The pair of cartridges 100, 100′ are configured to be mounted around the central core, opposite each other along a longitudinal axis of the central core. Each cartridge 100, 100′ comprises a first part 101, 101′ and a second part 102, 102′. The second part 102, 102′ is movable with respect to the first part 101, 101′ from the open position, shown in FIG. 1, to the closed position, shown in FIG. 2. In the shown embodiment, the second part 102, 102′ is pivotable with respect to the first part 101, 101′ around a pivot axis parallel with a central axis C of the cartridge 100, 100′.

The first part 101, 101′ comprises a first front axial side surface 110, 110′ and an opposite first rear axial side surface 111, 111′. Correspondingly, the second part 102. 102′ comprises second opposite front axial side surfaces 112, 112′ and rear axial side surfaces 113, 113′, respectively. The pair of cartridges 100, 100′ are arranged with said rear axial side surfaces 111, 111′ of the first parts 101, 101′ and the rear axial side surfaces 113, 113′ of the second parts 102, 102′ facing each other and with the front axial side surfaces 110, 110′, 112, 112′ facing away from each other.

As can be seen in FIGS. 1 and 2, the cartridge 100′ and the cartridge 100 are similar although not identical. For clarity, features present on both cartridges 100, 100′ will hereinafter only be described with reference to the cartridge 100.

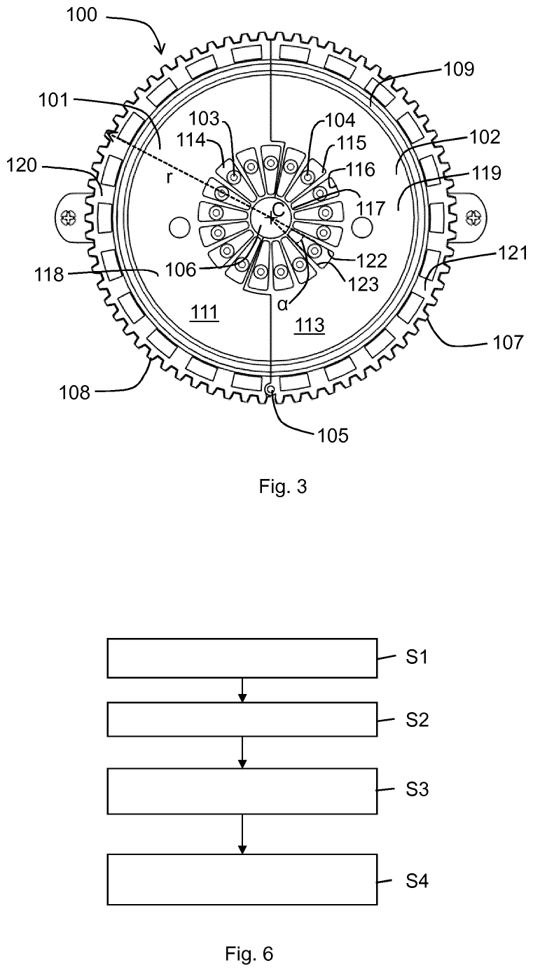

FIG. 3 illustrates the cartridge 100 from FIG. 1 in the closed position in closer detail, as seen from a rear end of the cartridge 100. The first part 101 comprises a first inner portion 118 in which a plurality of first through-holes 103 are provided, namely eight through-holes 103. The through-holes 103 for receiving a first plurality of the rods 2, each through-hole 103 being configured to receive one rod 2. The second part 102 comprises a second inner portion 119 in which a plurality of second through-holes 104, namely nine through-holes 104, for receiving a second plurality of the rods 2, are provided. In the shown embodiment, the through-holes 103, 104 are identical with a circular cross-section. A hinge joint 105 connects an outer portion 121 of the second part 102 to an outer portion 120 of the first part 101.

In the closed position, the first part 101 and the second part 102 together form an annular body extending around a central opening 106 for receiving the central core. The through-holes 103, 104 are arranged around the central opening 106 at equal radial distances to a central axis C of the cartridge 100 such that an angular distance between each pair of through-holes is equal or essentially equal. The cartridge 100 comprises a surface 107 configured to engage with a driving wheel for transfer of torque to the cartridge 100. In the shown embodiment, the surface 107 is a radially peripheral surface of the cartridge 100 provided on the outer portions 120, 121. The surface 107 is provided with teeth 108, forming an external spur gear, for meshing engagement with teeth of the driving wheel. An annular guiding groove 109 is formed between the inner parts 118, 119 and the outer parts 120, 121.

In the open position, a gap is provided between the first part 101 and the second part 102 so that the central opening 106 is accessible from a position radially outside of the cartridge 100.

A plurality of identical recesses 114, 115 are formed in the rear axial side surfaces 111, 113 of the first part 101 and the second part 102, respectively. Each of the through-holes 103, 104 is located in one of the recesses 114, 115. Each recess 114, 115 is wedge-shaped and delimited by side walls 122, 123 extending in a radial direction r or in an essentially radial direction of the cartridge 100, i.e. the recess 114, 115 is more narrow close to the central opening 106 than further away from the central opening 106. The side walls 122, 123 are offset by an angle α. The recess 114, 115 has a radial extension which is larger than a diameter of the through-hole 103, 104. Each of the recesses 114, 115 has an outer side wall 116 located radially outside of the through-hole 103, 104 and an inner side wall 117 located radially inside of the through-hole 103, 104. The inner side wall 117 and the outer side wall 116 may optionally be omitted.

Since the side walls 122, 123 extend in the radial direction r or in the essentially radial direction of the cartridge 100, the side walls 122, 123 converge toward the central core. The side walls 122, 123 thus frame and guide the rotating preformed rods 2 during rotation of the cartridges 100, 100′ around the central core, providing a smooth mounting process.

Reference is now again made to FIG. 2. The cartridge 100′ is essentially a mirrored version of the cartridge 100, but in which the inner portions 118′, 119′ are slightly twisted by a twisting angle of 20° or less around the central axis C with respect to the inner portions 118, 119 of the cartridge 100. This enables the tool 1 to hold the preformed helical rods 2 in a correct position. The reason for twisting only the inner portions 118′, 119′ in which the through-holes are provided, is that a larger common gap for receiving the central core is in this way provided than if also outer parts of the cartridge 100′ would be twisted.

The twisting angle depends on the length of the rods 2, wherein longer rods usually may require a smaller twisting angle. For particularly long rods it may be preferable to use a tool having four cartridges, one central pair of cartridges (central cartridges) with rear axial side surfaces facing each other, and one distal pair of cartridges (distal cartridges) positioned further away from a position between the central cartridges. The rear axial side surface of each distal cartridge thus faces the front axial side surface of a corresponding central cartridge. The twisting angle in the central pair of cartridges may in this case be set to 0°.

The twisting angle may further be set in dependence on for example a number of rods 2, a material of the rods 2, a diameter of the rods 2 and a helical pitch of the rods 2. A typical interval for the twisting angle may be [0, 2θ]°, wherein θ is defined as 360/n, wherein n is the number of rods 2.

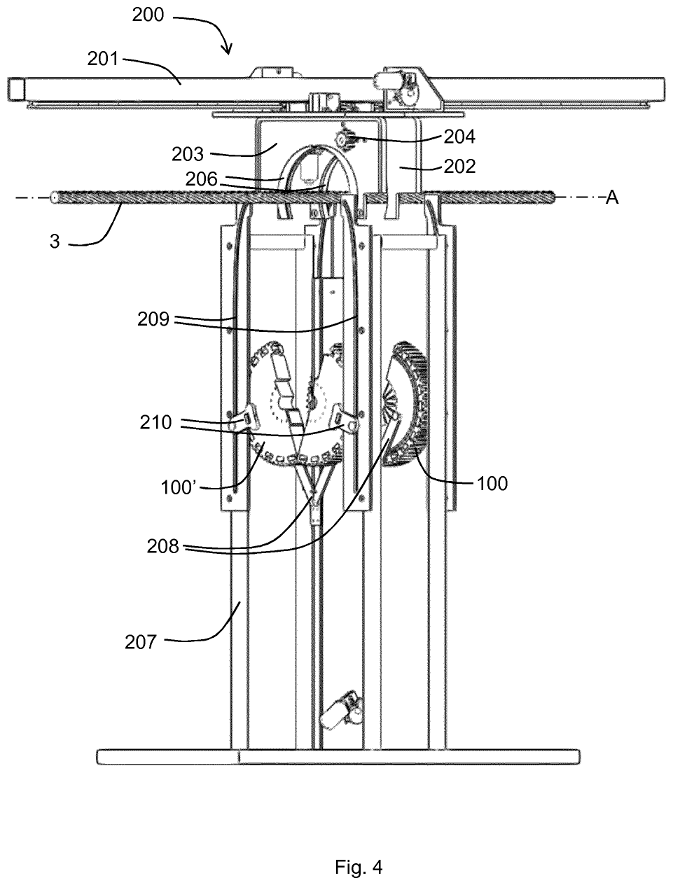

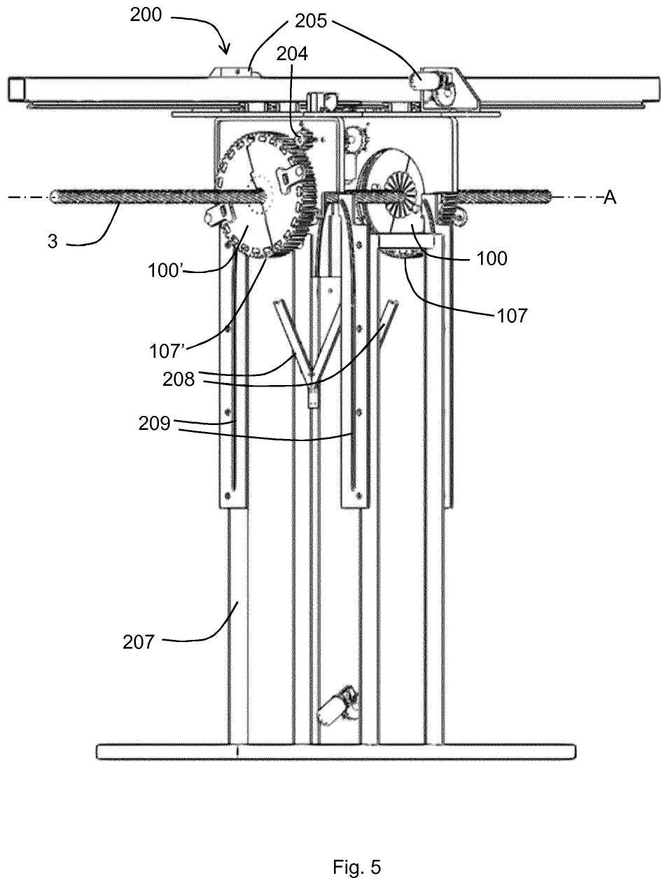

An apparatus 200 according to an embodiment of the invention is shown in FIGS. 4-5. The apparatus 200 comprises a tool 1 as described above with a pair of cartridges 100, 100′ facing each other. In FIG. 4, the apparatus is shown with the cartridges 100, 100′ in the open position, prior to mounting around a central core 3 extending along a longitudinal axis A. In FIG. 5, the apparatus is shown with the cartridges 100, 100′ mounted and rotated around the central core 3. For clarity, the apparatus 200 is shown without rods 2 loaded in the cartridges 100, 100′. The central axes C of the cartridges 100, 100′ are aligned with the longitudinal axis A.

The apparatus 200 further comprises a frame 201 with two frame members 202, 203. Each frame member 202, 203 is configured to hold one of the cartridges 100, 100′ centred on the central core 3. The frame members 202, 203 are movable along the longitudinal axis A on a guide rail of the frame 201. A rotational driving means comprising a first and a second driving wheel 204 (only one driving wheel is shown) in the form of pinions is provided. Each driving wheel 204 is configured to translate torque to one of the cartridges 100, 100′ by engagement with the radially peripheral surface 107, 107′ of the cartridges 100, 100′. A translational driving means for translating the frame members 202, 203 along the longitudinal axis A is further provided, comprising two linear drivers 205. A control means (not shown) configured to control the rotational driving means and the translational driving means is further provided. The control means is configured to control the tool 1 so that the cartridges 100, 100′ are rotated in opposite directions around the central core 3 until a predetermined condition is met, and so that the cartridges 100, 100′ are subsequently simultaneously rotated and translated in opposite directions around and along the central core 3, respectively, thereby wrapping the preformed helical rods 2 around the central core 3.

Each of the frame members 202, 203 comprises a protruding guiding flange 206 configured to engage with the guiding groove 109 of each cartridge 100, 100′.

The apparatus further comprises a mounting device 207 for mounting the cartridges 100, 100′ around the central core 3. The mounting device is configured to hold the cartridges 100, 100′ opposite one another in the open position, with the common gap facing the central core 3, and move them simultaneously in a radial direction r of the cartridges (upwards in the shown embodiment) until the cartridges 100, 100′ are centred on the central core 3, and subsequently close the cartridges. In the shown embodiment, the mounting device 207 comprises for each cartridge a spring-loaded cartridge lifter 208, a pair of slide guides 209, and a pair of guiding pins 210 configured to engage with on one hand the cartridges 100, 100′, and on the other hand the slide guides 209.

When a set of rods 2 are to be mounted around a central core 3, a pair of cartridges 100, 100′ pre-loaded with rods 2 are mounted in the apparatus using the guiding pins 210 to hold the cartridges 100, 100′ in the open position on the slide guides 209. The cartridge lifters 208 simultaneously contact the pre-loaded pair of cartridges 100, 100′ and move them upward along the slide guides 209. The distance between the slide guides 209 decreases in the upward direction. As the cartridges 100, 100′ approach the central core 3, the gap between them closes and they are thereby positioned centred on the central core 3. The frame members 202, 203 are thereafter moved away from each other along the longitudinal axis A so that the guiding flanges 206 are received in the guiding grooves 109 of the cartridges 100, 100′ and so that the driving wheels 204 engage with the surfaces 107. The guiding flanges 206 cover a total of more than 180° of a circumference of each cartridge 100, 100′, preventing the cartridge from falling out.

To mount the rods 2 around the central core 3, the cartridges 100, 100′ are rotated and translated in opposite directions around and along the central core 3 as will be further described below, using the rotational and the translational driving means.

Several pairs of pre-loaded cartridges in the open position may be loaded on the slide guides 209 of the apparatus 200, the slide guides thereby forming a magazine for the cartridges and rods. Downtime between subsequent wrapping operations is thereby minimized.

A method for mounting a set of preformed helical rods 2 around a central core 3 extending along a longitudinal axis A according to an embodiment of the invention is illustrated in the flow chart in FIG. 6. The method comprises the steps of:

S1) Providing a tool 1 in which the set of rods 2 are loaded in the pair of cartridges 100, 100′, each rod 2 being received in one of the through-holes 103, 104 of a first one of the cartridges 100 and one of the through-holes of a second one of the cartridges 100′ positioned opposite to the first cartridge 100 along the central axis C of the first cartridge 100. The rods may preferably be loaded in the pair of cartridges 100, 100′ so that a first point of contact between one of the rods 2 and the first cartridge 100 is separated from a second point of contact between said rod 2 and the second cartridge 100′ by an amount equal to a helical pitch of the rod 2. The pair of cartridges 100, 100′ may, after loading of the rods 2 in the through-holes 103, 104, be pushed toward each other to form a stable and rigid unit. The points of contact are thereby provided at the “top” of two adjacent sinus periods. The points of contact are defined by the through-holes 103, 104.

S2) With the cartridges 100, 100′ in the open position, positioning the pair of cartridges with the rods 2 loaded therein around the central core 3 and subsequently closing the cartridges 100, 100′ such that the central core 3 is received in the central opening 106 of each cartridge 100, 100′.

S3) Subsequently to closing the cartridges 100, 100′, rotating the cartridges 100, 100′ in opposite directions around the central core 3 until a predetermined condition is met. This rotation is preferably carried out simultaneously for both cartridges 100, 100′, although this is not necessary. Preferably, a driving wheel in meshing engagement with a radially peripheral surface of the cartridge 100, 00′ is used in this step. The predetermined condition may e.g. be considered to be met when at least one of the rods 2 comes into contact with the central core 3, and/or when the cartridges 100, 100′ have been rotated by a predetermined angular amount, such as 90° per cartridge in opposite directions.

S4) Subsequently to the predetermined condition being met, simultaneously rotating and translating the cartridges 100, 100′ in opposite directions around and along the central core 3, respectively, so that the rods 2 wrap around the central core 3. The ratio of the axial and rotational movement should be adjusted to the helical pitch of the preformed helical rods. For example, for rods having a helical pitch of 220 mm, each cartridge 100, 100′ should be rotated 360° per 220 mm.

Of course, the tool according to the invention may be used also in apparatuses having a different configuration than the above described apparatus. The tool may also be used for manual mounting of the rods around the central core, i.e. by rotating and translating the cartridges in opposite directions by hand. As mentioned above, the tool may also comprise more than one pair of cartridges, such as two pairs of cartridges.

Further modifications of the invention within the scope of the appended claims are feasible. As such, the present invention should not be considered as limited by the embodiments and figures described herein. Rather, the full scope of the invention should be determined by the appended claims, with reference to the description and drawings.

1. A tool (1) for mounting a set of preformed helical rods (2) around a central core (3) extending along a longitudinal axis (A), the tool (1) comprising a pair of cartridges (100, 100′) configured to hold the rods (2) and configured to be mounted around the central core (3) opposite each other along the longitudinal axis (A), so that the rods (2) extend along the central core (3), each cartridge (100, 100′) comprising at least:
a first part (101) comprising at least one through-hole (103) for receiving at least one of said rods (2),
a second part (102) comprising at least one through-hole (104) for receiving at least another one of said rods (2), the second part (102) being movable with respect to the first part (101) from an open position to a closed position,
wherein, in the closed position, the first part (101) and the second part (102) together form an annular body extending around a central opening (106) for receiving the central core (3), the through-holes (103, 104) being arranged around the central opening (106) at equal radial distances to a central axis (C) of the cartridge (100, 100′), the cartridge (100, 100′) comprising a surface (107, 107′) configured to engage with a driving wheel (204) or a driving belt for transfer of torque to the cartridge (100, 100′), and
wherein, in the open position, a gap is provided between the parts (101, 102) so that the central opening (106) is accessible from a position radially outside of the cartridge (100, 100′).

2. The tool (1) according to claim 1, wherein the second part (102) is configured to be pivotable with respect to the first part (101) around a pivot axis parallel with the central axis (C).

3. The tool (1) according to claim 1, wherein the first part (101) and the second part (102) each comprise a plurality of said through-holes (103, 104), respectively, wherein said through-holes (103, 104) are evenly distributed around the central axis (C).

4. The tool (1) according to claim 1, wherein the first part (101) and the second part (102) each comprise opposite front and rear axial side surfaces (110, 110′, 111, 111′, 112, 112′, 113, 113′), the cartridges (100, 100′) being arranged with said rear axial side surfaces (111, 111′, 113, 113′) facing each other, wherein each of said through-holes (103, 104) is located in a with said through-hole (103, 104) associated recess (114, 115) formed in the rear axial side surface (111, 111′, 113, 113′), wherein said recess (114, 115) is wedge-shaped and delimited by side walls (122, 123) extending in a radial or essentially radial direction (r) of the cartridge (100, 100′), wherein the side walls (122, 123) are offset by an angle (α).

5. The tool according to claim 4, wherein the recess (114, 115) has an extension in the radial direction (r) of the cartridge (100, 100′) which is larger than an extension of the through-hole (103, 104) in that direction, such that the recess (114, 115) extends at least from the through-hole (103, 104) and to an inner position located radially inside of the through-hole (103, 104).

6. The tool according to claim 4, wherein the recess (114, 115) extends from an outer position located radially outside of the through-hole (103, 104) to an inner position located radially inside of the through-hole (103, 104).

7. The tool according to claim 4, wherein the recess (114, 115) is delimited in the radial direction (r) by an outer side wall (116) located radially outside of the through-hole (103, 104) and an inner side wall (117) located radially inside of the through-hole (103, 104).

8. The tool (1) according to claim 1, wherein the surface (107, 107′) configured to engage with the driving wheel (204) or driving belt is a radially peripheral surface (107, 107′) of the annular body.

9. The tool (1) according to claim 1, wherein the surface (107) configured to engage with the driving wheel (204) or driving belt is configured for meshing engagement with a driving wheel (204).

10. A tool assembly comprising a tool (1) according to claim 1 and a set of preformed helical rods (2), each rod (2) being received in one of said through-holes (103, 104) of a first one of the cartridges (100) and one of said through-holes (103, 104) of a second one of the cartridges (100′) positioned opposite to the first cartridge (100) along the central axis (C) of the first cartridge (100) in such a manner that the tool (1) and the rods (2) form a rigid unit.

11. A method for mounting a set of preformed helical rods (2) around a central core (3) extending along a longitudinal axis (A), the method comprising:
providing a tool (1) according to claim 1, the set of rods (2) being loaded in the pair of cartridges (100, 100′), each rod (2) being received in one of said through-holes (103, 104) of a first one of the cartridges (100) and one of said through-holes (103, 104) of a second one of the cartridges (100′) positioned opposite to the first cartridge (100) along the central axis (C) of the first cartridge (100),
with the cartridges (100, 100′) in the open position, positioning the pair of cartridges (100, 100′) with the rods (2) loaded therein around the central core (3) and subsequently closing the cartridges (100, 100′) such that the central core (3) is received in the central opening (106) of each cartridge (100, 100′),
subsequently to closing the cartridges (100, 100′), rotating the cartridges (100, 100′) in opposite directions around the central core (3) until a predetermined condition is met,
subsequently to the predetermined condition being met, simultaneously rotating and translating the cartridges (100, 100′) in opposite directions around and along the central core (3), respectively, so that the rods (2) wrap around the central core (3).

12. The method according to claim 11, wherein rotating each cartridge (100, 100′) is carried out using a driving wheel (204) in meshing engagement with a surface (107, 107′) of the cartridge (100, 100′), preferably a radially peripheral surface (107, 107′) of the cartridge (100, 100′).

13. The method according to claim 11, wherein the predetermined condition is considered to be met when at least one of the rods (2) comes into contact with the central core (3).

14. The method according to claim 11, wherein the predetermined condition is considered to be met when the cartridges (100, 100′) have been rotated by a predetermined angular amount.

15. The method according to claim 11, wherein the rods (2) are loaded in the pair of cartridges (100, 100′) so that a first point of contact between one of the rods (2) and the first cartridge (100) is separated from a second point of contact between said rod (2) and the second cartridge (100′) by an amount equal to a helical pitch of said rod (2).

16. An apparatus (200) for mounting a set of preformed helical rods (2) around a central core (3) extending along a longitudinal axis (A), the apparatus (200) comprising a tool (1) according to claim 1, the apparatus further comprising:
a frame (201) comprising two frame members (202, 203), each frame member (202, 203) being configured to hold one of the cartridges (100, 100′) centred on the central core (3), wherein the frame members (202, 203) are movable along the longitudinal axis (A),
rotational driving means for rotating the cartridges (100, 100′),
translational driving means for translating the frame members (202, 203) along the longitudinal axis (A),
control means configured to control the rotational driving means and the translational driving means so that the cartridges (100, 100′) are rotated in opposite directions around the central core (3) until a predetermined condition is met, and so that the cartridges (100, 100′) are subsequently simultaneously rotated and translated in opposite directions around and along the central core (3), respectively.

17. The apparatus (200) according to claim 16, wherein the rotational driving means comprises a first and a second driving wheel (204) configured to translate torque to the cartridges (100, 100′) by engagement with surfaces (107, 107′) of a first one and a second one of the cartridges (100, 100′), respectively.

18. The apparatus according to claim 16, further comprising a mounting device (207) for mounting the cartridges (100, 100′) around the central core (3), wherein the mounting device (207) is configured to hold the cartridges (100, 100′) opposite one another in the open position, with the gaps facing the central core (3), and move the cartridges (100, 100′) simultaneously in a radial direction (r) of the cartridges (100, 100′) until the cartridges (100, 100′) are centred on the central core (3), and subsequently close the cartridges (100, 100′).
